(19) United States
(12) Patent Application Publication
(10) Pub. No.: US 2026/0081356 A1
(43) Pub. Date: Mar. 19, 2026

(54) ANTENNA ELEMENT, ANTENNA ARRAY, COMMUNICATION APPARATUS, AND CONTROL METHOD

(71) Applicant: Huawei Technologies Co., Ltd., Shenzhen (CN)

(72) Inventors: Hongfu Zhu, Shenzhen (CN); Hua Cai, Chengdu (CN); Ruyuan Deng, Shenzhen (CN); Yuan Liang, Chengdu (CN); Guangjian Wang, Chengdu (CN)

(21) Appl. No.: 19/396,862

(22) Filed: Nov. 21, 2025

Related U.S. Application Data
(63) Continuation of application No. PCT/CN2023/095905, filed on May 23, 2023.

(51) Int. Cl. H01Q 9/04; H01Q 1/38

(52) U.S. Cl. CPC H01Q 9/0442; H01Q 1/38

(57) ABSTRACT

An antenna element, an antenna array, a communication apparatus, and a control method, where the antenna element includes a radiator, a tuning member, and an electronic control component. The electronic control component includes a heating member, a first electrode, and a second electrode. One end of the heating member is connected to the tuning member, the other end of the heating member is electrically connected to both one end of the first electrode and one end of the second electrode, and both the other end of the first electrode and the other end of the second electrode are electrically connected to a control circuit. The heating member is configured to convert the voltage pulse into a thermal pulse, and conduct the thermal pulse to the tuning member, when the control circuit inputs a voltage pulse to the first electrode and the second electrode.

### CROSS-REFERENCE TO RELATED APPLICATIONS

This application is a continuation of International Application No. PCT/CN2023/095905, filed on May 23, 2023, the disclosure of which is hereby incorporated by reference in its entirety.

### TECHNICAL FIELD

This application relates to the field of antenna technologies, and in particular, to an antenna element, an antenna array, a communication apparatus, and a control method.

### BACKGROUND

Antennas are components used in wireless communication to convert energy, directionally radiates or receives electromagnetic waves. They are widely used in engineering systems such as radio communication, broadcasting, radars, navigation, and remote sensing. For example, antennas are used in electronic devices like mobile phones, notebook computers, tablet computers, netbooks, or wearable devices, enabling these electronic devices to perform signal transmission. With the continuous development and update of communication technologies, 6th generation wireless networks (6G) have attracted increasing attention due to their faster data transmission and ubiquitous wireless connectivity.

Currently, for high-frequency intelligent reconfigurable antenna arrays used in 6G communication technologies, related technologies provide an electrically controlled reconfigurable antenna array. Such an antenna array includes a plurality of antenna elements arranged in arrays, and each antenna element includes a plurality of radiators disposed at intervals and a varactor disposed between two adjacent radiators. A bias voltage is applied to the varactor, and a capacitance of the varactor changes, to change a characteristic of the antenna element, thereby implementing a reconfigurable characteristic of the antenna array.

However, in the antenna array, the varactor typically has a large size and a low cut-off frequency, making it challengeable to meet requirements of the antenna array in high-frequency communication technologies. In addition, a plurality of varactors need to be disposed in the antenna array, increasing manufacturing costs and production costs of the antenna array.

### SUMMARY

This application provides an antenna element, an antenna array, a communication apparatus, and a control method, to resolve a problem that an existing high-frequency antenna array has a large size and high costs.

A first aspect of this application provides an antenna element. The antenna element includes a radiator, a tuning member connected to the radiator, and an electronic control component.

The electronic control component includes a heating member, a first electrode, and a second electrode.

One end of the heating member is connected to the tuning member, the other end of the heating member is electrically connected to both one end of the first electrode and one end of the second electrode, and both the other end of the first electrode and the other end of the second electrode are electrically connected to a control circuit.

The heating member is configured to: when the control circuit inputs a voltage pulse to the first electrode and the second electrode, convert the voltage pulse into a thermal pulse, and conduct the thermal pulse to the tuning member.

The tuning member is used to induce phase transition between a metallic phase and an insulating phase when being subjected to the thermal pulse.

The tuning member and the electronic control component are disposed in the antenna element, and the electronic control component controls the tuning member, so that the tuning member can present different resistance states, and antenna elements in an antenna array have different phases, amplitudes, polarization, and frequencies, to implement an intelligent reconfigurable characteristic of the antenna array. The tuning member may be of any structure and size, and a manufacturing thickness of the tuning member may range from nanometers to micrometers, so that the antenna element can be designed in a small size, and the antenna array can be effectively used in a high-frequency band. Moreover, a structure of the tuning member is simple to manufacture and costs are low, so that material costs and manufacturing costs of the antenna array can be effectively reduced.

In addition, the tuning member has a high cut-off frequency and a low parasitic effect, and can implement effective tuning and application in a band of a high-frequency communication technology, thereby effectively meeting an intelligent reconfigurable requirement of a high-frequency antenna.

In a possible implementation, that the tuning member is used to induce the phase transition between the metallic phase and the insulating phase when being subjected to the thermal pulse includes:

The tuning member transitions from the metallic phase to the insulating phase when being subjected to a first thermal pulse; and
the tuning member transitions from the insulating phase to the metallic phase when being subjected to a second thermal pulse.

In a possible implementation, the antenna element further includes a first isolation layer, the first isolation layer is located between the heating member, and the tuning member and the radiator, and the tuning member is connected to the heating member via the first isolation layer. The first isolation layer may electrically isolate the heating member from the radiator and the tuning member, to reduce or avoid a case such as a short circuit caused by circuit conduction between the heating member, and the tuning member and the radiator. This helps improve stability and reliability of running of the antenna element, and improve safety of the antenna element. In addition, the first isolation layer can further perform a heat conduction function, so that a thermal pulse generated by the heating member can be conducted to the tuning member via the first isolation layer, to enable the tuning member to induce phase transition.

In a possible implementation, the antenna element further includes a second isolation layer, and the second isolation layer is located on a side at which the tuning member and the radiator face the heating member. A mounting groove is provided on a surface that is of the second isolation layer and that faces the tuning member and the radiator, and the heating member is located in the mounting groove. The second isolation layer may perform an electrical isolation function between two adjacent heating members, to reduce or avoid a case such as a short circuit caused by contact between the two adjacent heating members. This helps reduce a security risk, improve reliability and stability of running of the antenna element, and improve safety of the antenna element.

In a possible implementation, two first through holes are provided at a bottom of the mounting groove, and the first electrode and the second electrode respectively pass through the two first through holes. The first through hole is disposed on the second isolation layer. In this case, the first electrode and the second electrode may be disposed on a surface that is of the heating member and that faces away from the tuning member, and extend out of the antenna element through the two first through holes, to be electrically connected to the external control circuit. In this way, each electrode can independently pass through the first through hole, to effectively avoid contact, entanglement, or another phenomenon between the electrodes, so as to avoid a security risk such as a short circuit. This helps improve regularity of arrangement of the first electrode and the second electrode, and improve rationality and safety of the arrangement of the first electrode and the second electrode.

In a possible implementation, the antenna element further includes at least one of a substrate and a metal backplane. The substrate may provide a rigid support for the antenna element, and the metal backplane may reflect an electromagnetic wave signal, to generate resonant coupling. This helps improve radiation efficiency of the antenna element. In addition, the metal backplane reflects the electromagnetic wave signal, so that electromagnetic impact between the electromagnetic wave signal and a wire on the electronic control component can be reduced or avoided. This helps reduce parasitic impact of the electronic control component on radiation performance of the antenna element.

In a possible implementation, the antenna element includes the substrate and the metal backplane, the substrate is located on a surface that is of the second isolation layer and that faces away from the tuning member and the radiator, and the metal backplane is located on a surface that is of the substrate and that faces away from the second isolation layer.

The substrate is provided with two second through holes that are communicated with the first through holes. The metal backplane is provided with two third through holes that are communicated with the second through holes. The first electrode and the second electrode further pass through the second through holes and the third through holes in sequence. In this way, the first electrode may extend out of the antenna element by passing through a second through hole a and a third through hole a in sequence, to be electrically connected to the external control circuit, and the second electrode may extend out of the antenna element by passing through a second through hole b and a third through hole b in sequence, to be electrically connected to the external control circuit. This can effectively reduce or avoid entanglement between the first electrode and the second electrode, improve regularity of arrangement of the first electrode and the second electrode, and improve rationality of the arrangement of the first electrode and the second electrode.

In a possible implementation, the antenna element further includes a third isolation layer. The third isolation layer is located on a surface that is of the metal backplane and that faces away from the substrate. The third isolation layer is provided with two fourth through holes that are communicated with the third through holes, and the first electrode and the second electrode further pass through the fourth through holes. The third isolation layer may further perform an electrical isolation function, to reduce or avoid a case such as a short circuit caused by electrical contact between the first electrode and the second electrode. This helps improve safety of running of the antenna element. In addition, the third isolation layer may protect the antenna element, to reduce or avoid a case such as scratching between the antenna element and another external component.

In a possible implementation, one end of the tuning member is connected to one end of one radiator, and the other end of the tuning member is connected to one end of another radiator.

In a possible implementation, when the tuning member transitions from the metallic phase to the insulating phase, the radiator is electrically insulated from the another radiator via the tuning member; and/or
when the tuning member transitions from the insulating phase to the metallic phase, the radiator is electrically connected to the another radiator via the tuning member.

In a possible implementation, one end of the tuning member is connected to one end of the radiator, and the other end of the tuning member is connected to the other end of the radiator.

In a possible implementation, there are at least two tuning members, one end of one of the at least two tuning members is connected to one end of one radiator, and the other end of the tuning member is connected to one end of another radiator.

One end of another tuning member in the at least two tuning members is connected to the other end of the radiator, and the other end of the another tuning member in the at least two tuning members is connected to the other end of the another radiator.

In a possible implementation, a shape of the radiator includes at least one of a trapezoid, a sector, a rectangle, a circle, an annulus, or a polygon.

In a possible implementation, the antenna element further includes a passivation layer, and the passivation layer covers at least the tuning member. The passivation layer may protect the tuning member, to reduce or avoid external harmful impurities falling onto the tuning member, and prevent a surface of the tuning member from being contaminated.

In a possible implementation, a forming material of the tuning member is at least one of germanium telluride, antimony telluride, germanium antimony tellurium, and indium antimony tellurium.

In a possible implementation, a forming material of the heating member is metal tungsten or titanium tungsten alloy.

In a possible implementation, a forming material of the radiator is at least one of gold, copper, and aluminum.

In a possible implementation, a forming material of the first isolation layer is at least one of aluminum nitride, silicon nitride, silicon dioxide, silicon carbide, and aluminum oxide.

In a possible implementation, a forming material of the second isolation layer is at least one of aluminum nitride, silicon nitride, silicon dioxide, silicon carbide, and aluminum oxide.

A second aspect of this application provides an antenna array, including a plurality of the foregoing antenna elements. The plurality of antenna elements are arranged in an array.

A third aspect of this application provides a communication apparatus, including the foregoing antenna array.

A fourth aspect of this application provides a control method, used to control any one of the foregoing antenna elements. The method includes:
inputting a voltage pulse to the first electrode and the second electrode in the antenna element, to enable the tuning member to transition from a metallic phase to an insulating phase, so that the antenna element radiates and receives a signal by using the radiator; and
inputting another voltage pulse to the first electrode and the second electrode, to enable the tuning member to transition from an insulating phase to a metallic phase, so that the antenna element radiates and receives the signal by using both the radiator and the tuning member.

### BRIEF DESCRIPTION OF THE DRAWINGS

FIG. 1 is a diagram of a structure of a front surface of an antenna array according to an embodiment of this application;

FIG. 2 is a diagram of a structure of a back surface of an antenna array according to an embodiment of this application;

FIG. 3 is a diagram of a structure of a front surface of a first type of antenna element according to an embodiment of this application;

FIG. 4 is a diagram of a structure of a back surface of a first type of antenna element according to an embodiment of this application;

FIG. 5 is a sectional view of a first type of antenna element under a cross section according to an embodiment of this application;

FIG. 6 is a sectional view of a first type of antenna element under another cross section according to an embodiment of this application;

FIG. 7 is an exploded view of an antenna element according to an embodiment of this application;

FIG. 8 is a diagram of a structure of a second isolation layer according to an embodiment of this application;

FIG. 9 is a diagram of a structure of a substrate according to an embodiment of this application;

FIG. 10 is a diagram of a structure of a metal backplane according to an embodiment of this application;

FIG. 11 is a diagram of a structure of a third isolation layer according to an embodiment of this application;

FIG. 12 is a circuit connection diagram of a first electrode and a second electrode according to an embodiment of this application;

FIG. 13 is a diagram of a structure of a second type of antenna element according to an embodiment of this application;

FIG. 14 is a diagram of a structure of a third type of antenna element according to an embodiment of this application;

FIG. 15 is a diagram of a phase transition principle of a tuning member according to an embodiment of this application;

FIG. 16 is a diagram of a structure of a first combination of a radiator and a tuning member according to an embodiment of this application;

FIG. 17 is a diagram of a structure of a second combination of a radiator and a tuning member according to an embodiment of this application;

FIG. 18 is a diagram of a structure of a third combination of a radiator and a tuning member according to an embodiment of this application;

FIG. 19 is a diagram of a structure of a fourth combination of a radiator and a tuning member according to an embodiment of this application;

FIG. 20 is a diagram of a structure of a fifth combination of a radiator and a tuning member according to an embodiment of this application;

FIG. 21 is a diagram of a structure of a sixth combination of a radiator and a tuning member according to an embodiment of this application;

FIG. 22 is a diagram of a size of an antenna element according to an embodiment of this application;

FIG. 23 is a diagram of comparison between antenna phases of an antenna element when a tuning member is in a metallic phase and an insulating phase according to an embodiment of this application;

FIG. 24 is a diagram of comparison between antenna reflection amplitudes of an antenna element when a tuning member is in a metallic phase and an insulating phase according to an embodiment of this application; and

FIG. 25 is a flowchart of a control method of an antenna element according to an embodiment of this application.

### DESCRIPTION OF REFERENCE NUMERALS

100-Antenna element;
110-Radiator; 111-Radiation branch;
120-TUNING MEMBER;
130-Electronic control component; 131-Heating member; 132-First electrode; 133-Second electrode; 134-Wire;
140-First isolation layer;
150-Second isolation layer; 151-Mounting groove; 152-First through hole;
160-Substrate; 161-Second through hole;
170-Metal backplane; 171-Third through hole;
180-Third isolation layer; 181-Fourth through hole;
190-Passivation layer; 191-Fifth isolation layer; and
200-Antenna array.

### DETAILED DESCRIPTION OF ILLUSTRATIVE EMBODIMENTS

Terms used in implementations of this application are merely intended to explain specific embodiments of this application, but are not intended to limit this application.

With continuous development and update of communication technologies, a 6th generation communication network (6G) will undoubtedly become a future development direction due to features of faster data transmission and ubiquitous wireless connections. A millimeter wave and a terahertz wave, with features of higher frequencies and wider bandwidths, provide significant potential for a 6G wireless communication technology.

In the 6G communication technology, an intelligent reconfigurable antenna array is usually used to radiate and receive an electromagnetic wave signal. For example, in a related technology, an electrically controlled reconfigurable antenna array is provided. The antenna array includes a plurality of antenna elements arranged in an array. Each antenna element includes a metal ground layer, a metal radiation layer, and a dielectric layer disposed between the metal ground layer and the metal radiation layer. The metal radiation layer includes a plurality of radiators disposed at intervals, and each antenna element further includes a plurality of varactors. The plurality of varactors are separately disposed between two adjacent radiators disposed at intervals, so that the two adjacent radiators disposed at intervals can be electrically connected by using the varactor. The varactor is connected to a bias network, and the bias network is configured to provide a bias voltage for the varactor, to change a capacitance value of the varactor, so as to change an effective reactance value of the antenna element, thereby implementing a reconfigurable characteristic of the antenna array.

However, an antenna size is usually related to a frequency of a signal, and the antenna size is typically ½ to 1/10 of a signal wavelength. In 6G communication technologies, signals of the millimeter wave and the terahertz wave have high frequencies and short wavelengths. Therefore, antenna sizes corresponding to the signals are also small. However, in the foregoing antenna array, the varactor has a fixed structure and a large size, making it difficult to meet antenna array requirements of the 6G communication technologies.

Moreover, an antenna array usually includes hundreds of antenna elements arranged in an array, and a plurality of varactors need to be disposed on each antenna element. In this way, thousands of varactors need to be mounted in one antenna array. A mounting process is complex and costly, and this greatly increases a production difficulty and production costs of the antenna array.

In addition, the varactor has a large parasitic effect and a low cut-off frequency at a high frequency, which makes the varactor difficult to be tuned and used in a high-frequency band in the 6G communication technology.

In another related technology, an antenna array based on a light-controlled phase transition material is provided. Each antenna element in the antenna array includes a phase transition structure and a radiator disposed on the phase transition structure. To meet laser light-controlled phase transition and independent phase transition control on each antenna element in the antenna array, a laser needs to be correspondingly disposed in each phase transition structure in the antenna array. The laser is configured to emit a laser pulse to the phase transition structure, so that the phase transition structure induces phase transition between a metallic phase and an insulating phase metal-insulator transition when being subjected to the laser pulse, to change a characteristic of the antenna element, thereby implementing a reconfigurable characteristic of the antenna array.

However, the laser is expensive. The laser needs to be correspondingly disposed in each phase transition structure in the antenna array, and coding control needs to be performed on each laser. In addition, a size of a radiator corresponding to a signal band in the 6G communication technology is usually at a micrometer magnitude. Therefore, the laser needs to achieve precise focusing at a micrometer magnitude in space. It is difficult for a plurality of lasers to perform precise focusing during engineering implementation, and costs are high. This greatly increases costs and an implementation difficulty of the antenna array.

To resolve the foregoing problem, in the present invention, the antenna element, a tuning structure, and a control manner are improved. A tuning member and an electronic control component are disposed in the antenna element, and the electronic control component controls the tuning member, so that the tuning member can present different resistance states, and antenna elements in the antenna array have different phases, amplitudes, polarization, and frequencies, to implement an intelligent reconfigurable characteristic of the antenna array. The tuning member may be of any structure and size, and a manufacturing thickness of the tuning member may range from nanometers to micrometers, so that the antenna element can be designed in a small size, and the antenna array can be effectively used in a high-frequency band. Moreover, a structure of the tuning member is simple to manufacture and costs are low, so that material costs and manufacturing costs of the antenna array can be effectively reduced.

The following describes in detail the antenna element provided in embodiments of this application with reference to the accompanying drawings.

An embodiment of this application provides an antenna element. The antenna element may be a high-frequency antenna. For example, the antenna element may receive and radiate electromagnetic wave signals of millimeter and terahertz wave bands that correspond to 6G communication technologies. The antenna element may be used in scenarios such as programmable holographic imaging systems, adaptive intelligent sensing systems, new-system wireless communication systems, and communication base stations.

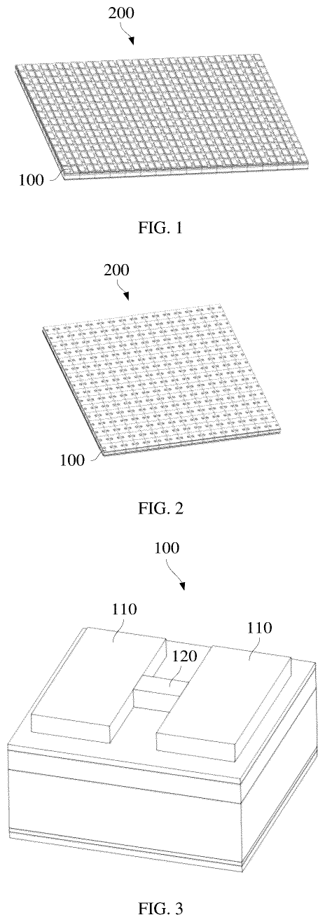

FIG. 1 is a diagram of a structure of a front surface of an antenna array according to an embodiment of this application. FIG. 2 is a diagram of structure of a back surface of an antenna array according to an embodiment of this application.

Refer to FIG. 1 and FIG. 2. An antenna element 100 may be used in the antenna array 200. For example, the antenna array 200 may include a plurality of antenna elements 100, and the plurality of antenna elements 100 may be arranged in an array. For example, the antenna elements 100 may be arranged in a form of M rows×N columns, to form the antenna array 200. A value of M may be greater than or equal to 2, and a value of N may also be greater than or equal to 2.

The antenna array 200 may further include a feed (not shown in the figure). The feed may feed an electromagnetic wave signal into the antenna element 100 in the antenna array 200, so that the antenna element 100 can radiate the signal to the outside by using a radiator after receiving the electromagnetic wave signal. For example, a feeding form of the feed may include space feeding and forced feeding. The space feeding may be understood as that the feed feeds the electromagnetic wave signal into the antenna element 100 in an electrical coupling manner. The forced feeding may be understood as that there is an electrical connection relationship between the feed and the antenna element 100. For example, the feed is electrically connected to the antenna element 100 by using a metal spring, welding, or the like, so that a signal on the feed can be fed into the antenna element 100, and the signal can be radiated to the outside by using the antenna element 100. For example, a function form of the antenna array 200 may include a reflective type, a transmissive type, a radiative type, and the like.

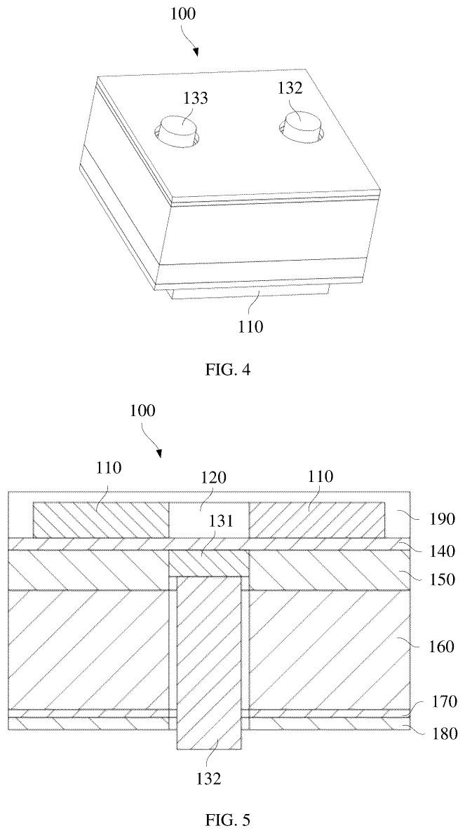

FIG. 3 is a diagram of a structure of a front surface of a first type of antenna element according to an embodiment of this application. FIG. 4 is a diagram of a structure of a back surface of a first type of antenna element according to an embodiment of this application.

Refer to FIG. 3 and FIG. 4. The antenna element 100 may include a radiator 110, a tuning member 120 connected to the radiator 110, and an electronic control component 130 (as shown in FIG. 5). There may be a plurality of quantities of radiators 110 and tuning members 120. For example, as shown in FIG. 3, the antenna element 100 may include two radiators 110 and one tuning member 120, and the tuning member 120 may be separately connected to the two radiators 110, so that the two radiators 110 can be connected by using the tuning member 120. Alternatively, the antenna element 100 further includes one radiator 110 and one tuning member 120, and the radiator 110 may be connected to the tuning member 120. Alternatively, in some examples, the antenna element 100 may include a plurality of radiators 110 and a plurality of tuning members 120, and the plurality of radiators 110 may be connected to the plurality of tuning members 120 in a plurality of combination forms. Quantities and arrangement forms of radiators 110 and tuning members 120 may be selected and set based on a specific application scenario.

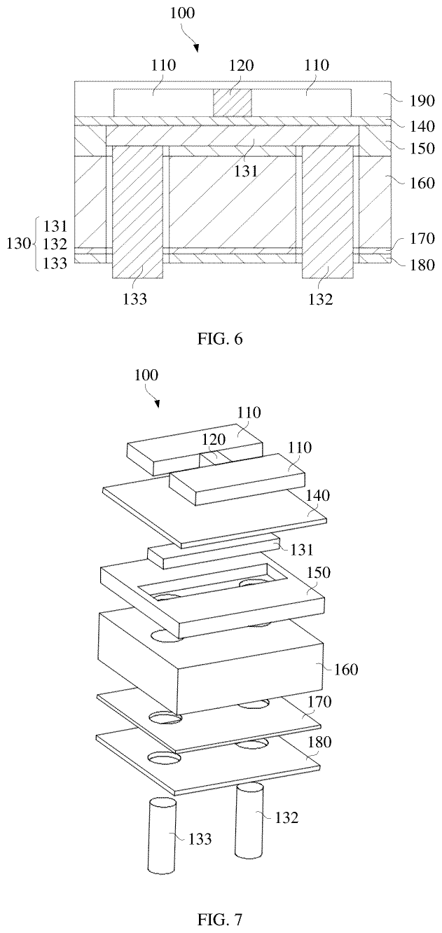

FIG. 5 is a sectional view of a first type of antenna element under a cross section according to an embodiment of this application. FIG. 6 is a sectional view of a first type of antenna element under another cross section according to an embodiment of this application.

With reference to FIG. 5 and FIG. 6, the electronic control component 130 may include a heating member 131, a first electrode 132, and a second electrode 133. One end of the heating member 131 may be connected to the tuning member 120, the other end of the heating member 131 may be electrically connected to both one end of the first electrode 132 and one end of the second electrode 133, and the other end of the first electrode 132 and the other end of the second electrode 133 may be electrically connected to a control circuit (not shown in the figure).

The control circuit may input a voltage pulse to the first electrode 132 and the second electrode 133. The voltage pulse may be transmitted to the heating member 131 by using the first electrode 132 and the second electrode 133. The heating member 131 may generate heat when being subjected to the voltage pulse, to convert the voltage pulse into a thermal pulse and conduct the thermal pulse to the tuning member 120. The tuning member 120 induces phase transition between a metallic phase and an insulating phase when being subjected to the thermal pulse. For example, the tuning member 120 may be a mechanical part made of a material for metal-insulator transition. When the tuning member 120 is subjected to different thermal pulses, the tuning member 120 may present different crystal structures and energy band structures, so that the tuning member 120 presents different resistance states. For example, the tuning member 120 may present a high-resistance state and a low-resistance state in different crystal structures. When the tuning member 120 is in the high-resistance state, the tuning member 120 may be understood as an electrical insulation member. In this case, the tuning member 120 is in the insulating phase. On the contrary, when the tuning member 120 is in the low-resistance state, the tuning member 120 may be understood as a conductive member. In this case, the tuning member 120 is in the metallic phase.

Certainly, in some examples, one heating member 131 may be correspondingly connected to a plurality of electrodes. A voltage pulse is input to two electrodes at different locations in the heating member 131, so that the heating member 131 can generate a thermal pulse at different locations. In this embodiment of this application, an example in which one heating member 131 is correspondingly connected to two electrodes (that is, the first electrode 132 and the second electrode 133) is used for description.

For example, based on different input parameters of the voltage pulse, correspondingly, thermal pulses obtained through conversion by the heating member 131 are also different. When being subjected to different thermal pulses, the tuning member 120 may transition from the metallic phase to the insulating phase, or transition from the insulating phase to the metallic phase. For example, the tuning member 120 may induce non-volatile metal-insulator transition. The “non-volatile” means that when the tuning member 120 is subjected to a thermal pulse and induces phase transition to present the metal phase, the tuning member 120 always remains in the metallic phase before being subjected to another thermal pulse. The tuning member 120 does not induce phase transition and does not present the insulating phase until being subjected to another thermal pulse. On the contrary, when the tuning member 120 is subjected to a thermal pulse and induces phase transition to present the insulating phase, the tuning member 120 always remains in the insulating phase before being subjected to another thermal pulse. The tuning member 120 does not induce phase transition and does not present the metallic phase until being subjected to another thermal pulse.

In an application process, different forms of thermal pulses may be applied to the tuning member 120 according to an application requirement, so that the tuning member 120 induces different phase transition, to present different resistance states. For example, when the tuning member 120 presents the insulating phase, only the radiator 110 in the antenna element 100 can radiate and receive an electromagnetic wave signal, that is, an effective radiation structure of the antenna element 100 is a structure of the radiator 110. When the tuning member 120 presents the metallic phase, both the radiator 110 and the tuning member 120 in the antenna element 100 can radiate and receive an electromagnetic wave signal, that is, an effective radiation structure of the antenna element 100 is a structure formed by both the radiator 110 and the tuning member 120. In this way, when the tuning member 120 is in different resistance states, the antenna element 100 may have different structures and electromagnetic properties, so that the antenna element 100 can have different phases, amplitudes, polarization, and frequencies.

A group of electronic control components 130 may be correspondingly disposed for one tuning member 120. Alternatively, in some examples, a group of electronic control components 130 may further control a plurality of tuning members 120 simultaneously. In this case, the plurality of tuning members 120 may implement synchronous phase transition by using the group of electronic control components 130. Quantities of tuning members 120 and electronic control components 130 may be selected and set based on a structure of the antenna element 100 and a specific application scenario.

For example, in an actual application process, array coding may be performed on the control circuit, to control the control circuit by using a control program that is compiled in advance, so that the control circuit can apply a voltage pulse to each heating member 131 in a preset manner. The heating member 131 may convert the voltage pulse into a thermal pulse when being subjected to the voltage pulse, so that the heating member 131 can apply different thermal pulses to the tuning member 120. For example, tuning members 120 in antenna elements 100 of the antenna array 200 may present different resistance states, so that the antenna elements 100 of the antenna array 200 have different phases, amplitudes, polarization, and frequencies. In this way, the antenna array 200 can actively and intelligently control an electromagnetic wave signal in space, so that the antenna array 200 can become an electromagnetic field with a controllable phase, a controllable amplitude, controllable polarization, and a controllable frequency, thereby implementing an intelligent reconfigurable characteristic of the antenna array 200. For example, the antenna array 200 may implement beam sweeping, beam deflection, beam focusing, spatial coding, and the like.

In comparison with a related technology in which a reconfigurable characteristic of an antenna structure is implemented by using a varactor, in this embodiment of this application, the tuning member 120 and the electronic control component 130 are disposed in the antenna element 100, and the electronic control component 130 controls the tuning member 120, so that the tuning member 120 can present different resistance states, and the antenna elements 100 in the antenna array 200 have different phases, amplitudes, polarization, and frequencies, to implement the intelligent reconfigurable characteristic of the antenna array 200. The tuning member 120 may be of any structure and size, and a manufacturing thickness of the tuning member 120 may range from nanometers to micrometers, so that the antenna element 100 can be designed in a small size, and the antenna array 200 can be effectively used in a high-frequency band. Moreover, a structure of the tuning member 120 is simple to manufacture and costs are low, so that material costs and manufacturing costs of the antenna array 200 can be effectively reduced.

In addition, the tuning member 120 has a high cut-off frequency and a low parasitic effect, and can implement effective tuning and application in a band of a high-frequency communication technology, thereby effectively meeting an intelligent reconfigurable requirement of a high-frequency antenna.

In comparison with another related technology in which a reconfigurable characteristic of an antenna structure is implemented by using a laser, in this embodiment of this application, the electronic control component 130 can control the tuning member 120, so that the tuning member 120 presents different resistance states, to implement the reconfigurable characteristic of the antenna array 200. In addition, a high-price laser is not required, and each tuning member 120 can be precisely and accurately controlled. Control of the electronic control component 130 is simple and costs are low, so that costs and an implementation difficulty of the antenna array 200 can be effectively reduced.

Still refer to FIG. 6. The antenna element 100 may further include a passivation layer 190, and the passivation layer 190 may cover at least the tuning member 120. For example, the passivation layer 190 may cover only on the tuning member 120, or the passivation layer 190 may be disposed on both the tuning member 120 and the radiator 110. The passivation layer 190 may protect the tuning member 120, to reduce or avoid damage (such as oxidation and moisture) caused by an external environment to the tuning member 120, avoid harmful impurities falling onto the tuning member 120, and prevent a surface of the tuning member 120 from being contaminated. This helps improve stability of using the tuning member 120 and prolong a service life.

FIG. 7 is an exploded view of an antenna element according to an embodiment of this application.

Refer to FIG. 6 and FIG. 7, the antenna element 100 may further include a first isolation layer 140. The first isolation layer 140 may be located between the heating member 131, and the radiator 110 and the tuning member 120, and the tuning member 120 may be connected to the heating member 131 via the first isolation layer 140. The first isolation layer 140 may electrically isolate the heating member 131 from the radiator 110 and the tuning member 120, to reduce or avoid a case such as a short circuit caused by circuit conduction between the heating member 131, and the tuning member 120 and the radiator 110. This helps improve stability and reliability of running of the antenna element 100 and improve safety of the antenna element 100. In addition, the first isolation layer 140 can further perform a heat conduction function, so that a thermal pulse generated by the heating member 131 can be conducted to the tuning member 120 via the first isolation layer 140, to enable the tuning member 120 to induce phase transition.

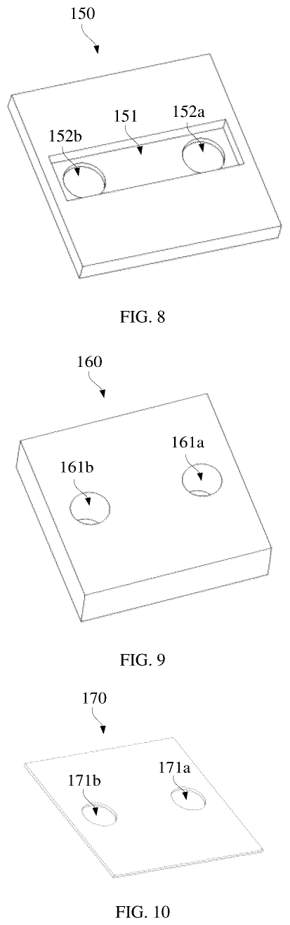

FIG. 8 is a diagram of a structure of a second isolation layer according to an embodiment of this application.

Still refer to FIG. 6 and FIG. 7. The antenna element 100 may further include a second isolation layer 150. The second isolation layer 150 may be located on a side at which the radiator 110 and the tuning member 120 face the heating member 131. For example, the second isolation layer 150 may be disposed on a surface that is of the first isolation layer 140 and that faces away from the tuning member 120.

With reference to FIG. 8, a mounting groove 151 may be provided on a surface that is of the second isolation layer 150 and that faces the radiator 110 and the tuning member 120, and the heating member 131 may be located in the mounting groove 151. A quantity of mounting grooves 151 may be set based on a quantity of heating members 131. For example, when there is one tuning member 120 in the antenna element 100, and there is also one corresponding electronic control component 130, there is also one heating member 131 in the antenna element 100, and one mounting groove 151 may be provided on the second isolation layer 150. Alternatively, when there are a plurality of tuning members 120 in the antenna element 100, and one electronic control component 130 is correspondingly disposed for each tuning member 120, there are also a plurality of tuning members 120 in the antenna element 100, and a plurality of mounting grooves 151 may be provided on the second isolation layer 150.

The mounting groove 151 may enable the heating member 131 to be embedded in the second isolation layer 150, so that a raised part generated by the heating member 131 on the second isolation layer 150 can be reduced or avoided. In this way, the tuning member 120 and the radiator 110 that are located above the second isolation layer 150 can be located in a same plane. This helps improve flatness of a connection between the tuning member 120 and the radiator 110, and improve stability and reliability of the connection between the tuning member 120 and the radiator 110. In addition, the mounting groove may also fasten the heating member 131, to reduce or avoid movement of the heating member 131, thereby helping improve firmness and reliability of the heating member 131 and improve stability of running of the antenna element 100.

The second isolation layer 150 may perform an electrical isolation function between two adjacent heating members 131, to reduce or avoid a case such as a short circuit caused by contact between the two adjacent heating members 131. This helps reduce a security risk, improve reliability and stability of running of the antenna element 100, and improve safety of the antenna element 100.

In some related technologies, a first electrode and a second electrode are usually disposed on a surface that is of a heating member and that faces a tuning member, and the electrodes, the tuning member, and a control circuit are all located on a same side of the heating member. This results in a highly congested layout between the electrodes, the control circuit, a radiator, and the tuning member, and parasitic capacitances are generated between the electrodes and the radiator and the tuning member and between the control circuit and the radiator and the tuning member, affecting radiation performance of an antenna element. In addition, as a size of the antenna element decreases, and a scale of an antenna element array increases at a high frequency, quantities of electrodes and control circuits that are independently controlled by the antenna element also increase accordingly. This significantly increases a layout difficulty of a circuit, and reduces rationality of arrangement of the electrodes and the control circuit.

Still refer to FIG. 8. Two first through holes 152 may be provided at a bottom of the mounting groove 151, and the first electrode 132 and the second electrode 133 may respectively pass through the two first through holes 152. For example, the two first through holes 152 may be respectively a first through hole 152a and a first through hole 152b, the first electrode 132 may pass through the first through hole 152a, and the second electrode 133 may pass through the first through hole 152b. The first electrode 132 and the second electrode 133 may extend out of the antenna element 100 through the two first through holes 152, and are electrically connected to the control circuit in the antenna array 200 by using parts extending out of the antenna element 100.

In comparison with the foregoing electrode disposing manner, in this embodiment of this application, the first through hole 152 is disposed on the second isolation layer 150. In this case, the first electrode 132 and the second electrode 133 may be disposed on a surface that is of the heating member 131 and that faces away from the tuning member 120, and extend out of the antenna element 100 through the two first through holes 152, to be electrically connected to the external control circuit. In this way, each electrode may independently pass through the first through hole 152, and the electrode extends, through the first through hole 152, to an external surface that is of the antenna element 100 and that faces away from the tuning member 120, so that the radiator 110 and the tuning member 120 can be effectively separated from the electrode and the control circuit, to avoid adverse impact, on radiation performance of the antenna element, caused by additional effects such as electromagnetic coupling and a parasitic capacitance that are generated due to mutual crosstalk between the foregoing components. In addition, contact, entanglement, or another phenomenon between the electrodes can be effectively avoided, and a security risk such as a short circuit is avoided. This helps improve regularity of arrangement of the first electrode 132 and the second electrode 133, and improve rationality and safety of the arrangement of the first electrode 132 and the second electrode 133.

FIG. 9 is a diagram of a structure of a substrate according to an embodiment of this application. FIG. 10 is a diagram of a structure of a metal backplane according to an embodiment of this application.

Still refer to FIG. 7. The antenna element 100 may further include at least one of a substrate 160 and a metal backplane 170. For example, only one substrate 160 may be disposed in the antenna element 100, and the substrate 160 may be located on a surface that is of the second isolation layer 150 and that faces away from the tuning member 120. Alternatively, only one metal backplane 170 may be disposed in the antenna element 100, and the metal backplane 170 may be disposed on a surface that is of the second isolation layer 150 and that faces away from the tuning member 120. The substrate 160 may provide a rigid support for the antenna element 100, to improve overall structure stability of the antenna element 100. The metal backplane 170 may reflect an electromagnetic wave signal, to generate resonant coupling. This helps improve radiation efficiency of the antenna element. In addition, the metal backplane 170 reflects the electromagnetic wave signal, so that electromagnetic impact between the electromagnetic wave signal and a wire 134 (as shown in FIG. 12) on the electronic control component 130 can be reduced or avoided. This helps reduce parasitic impact of the electronic control component 130 on radiation performance of the antenna element 100.

Alternatively, in some examples, the antenna element 100 may further include both a substrate 160 and a metal backplane 170. The substrate 160 may be located on a surface that is of the second isolation layer 150 and that faces away from the tuning member 120 and the radiator 110. The metal backplane 170 may be located on a surface that is of the substrate 160 and that faces away from the second isolation layer 150. With reference to FIG. 9 and FIG. 10, the substrate 160 may be provided with two second through holes 161 that are communicated with the first through holes 152, and the metal backplane 170 may be provided with two third through holes 171 that are communicated with the second through holes 161. The first electrode 132 and the second electrode 133 may pass through the second through holes 161 and the third through holes 171 in sequence.

For example, the two second through holes 161 on the substrate 160 may be respectively a second through hole 161a and a second through hole 161b, and the two third through holes 171 may be respectively a third through hole 171a and a third through hole 171b. The first electrode 132 may pass through the second through hole 161a and the third through hole 171a in sequence, and the second electrode 133 may pass through the second through hole 161b and the third through hole 171b in sequence. In this way, the first electrode 132 may extend out of the antenna element 100 by passing through the second through hole 161a and the third through hole 171a in sequence, to be electrically connected to the external control circuit, and the second electrode 133 may extend out of the antenna element 100 by passing through the second through hole 161b and the third through hole 171b in sequence, to be electrically connected to the external control circuit. This can effectively reduce or avoid entanglement between the first electrode 132 and the second electrode 133, improve regularity of arrangement of the first electrode 132 and the second electrode 133, and improve rationality of the arrangement of the first electrode 132 and the second electrode 133.

Still refer to FIG. 7. The antenna element 100 may further include a third isolation layer 180, and the third isolation layer 180 may be located on a surface that is of the metal backplane 170 and that faces away from the substrate 160. The other end of the first electrode 132 and the other end of the second electrode 133 may be laid along the third isolation layer 180, and extend out of the antenna element 100, to be electrically connected to the control circuit. The third isolation layer 180 may further perform an electrical isolation function, to reduce or avoid a case such as a short circuit caused by electrical contact between the first electrode 132 and the second electrode 133. This helps improve safety of running of the antenna element 100. In addition, the third isolation layer 180 may protect the antenna element 100, to reduce or avoid a case such as scratching between the antenna element 100 and another external component.

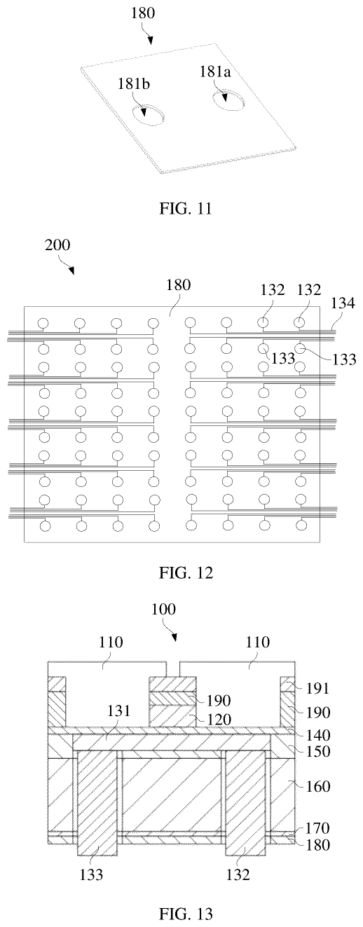

FIG. 11 is a diagram of a structure of the third isolation layer 180 according to an embodiment of this application. FIG. 12 is a circuit connection diagram of the first electrode 132 and the second electrode 133 according to an embodiment of this application.

Refer to FIG. 11. The third isolation layer 180 may be provided with two fourth through holes 181 that are communicated with the third through holes 171, and the first electrode 132 and the second electrode 133 may further pass through the two fourth through holes 181. For example, the two fourth through holes 181 may be respectively a fourth through hole 181a and a fourth through hole 181b, the first electrode 132 may pass through the fourth through hole 181a, and the second electrode 133 may pass through the fourth through hole 181b. After passing through the two fourth through holes 181, the first electrode 132 and the second electrode 133 may extend along a surface of the third isolation layer and extend out of the antenna element 100, to be electrically connected to the control circuit.

Refer to FIG. 12. For example, after the first electrode 132 and the second electrode 133 in each antenna element 100 distributed in the array extend from the third isolation layer 180, one end of the first electrode 132 and one end of the second electrode 133 extending from the third isolation layer 180 may be electrically connected to the wire 134, and each wire 134 may extend along the third isolation layer 180 and extend out of the antenna array 200, to be electrically connected to the control circuit. A voltage pulse on the control circuit may be transmitted to the first electrode 132 and the second electrode 133 through the wire 134.

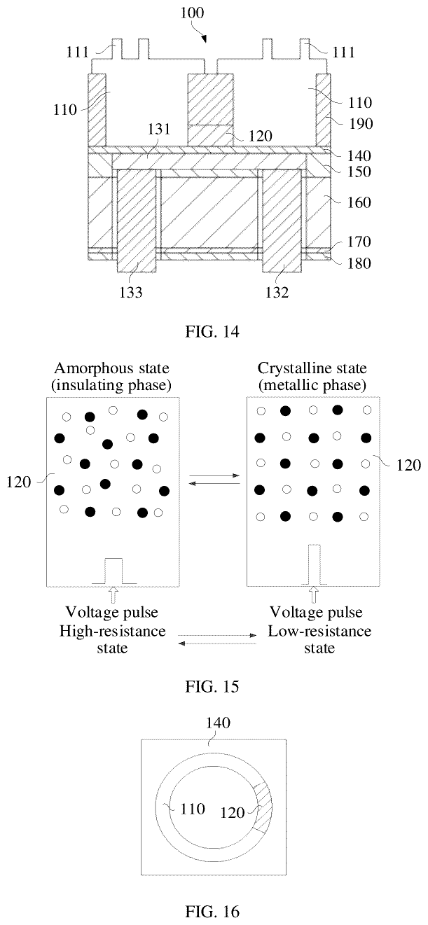

FIG. 13 is a diagram of a structure of a second type of antenna element according to an embodiment of this application. FIG. 14 is a diagram of a structure of a third type of antenna element according to an embodiment of this application.

Refer to FIG. 13. In some examples, the antenna element 100 may further include a fifth isolation layer 191, and the fifth isolation layer 191 may be disposed on a surface that is of the passivation layer 190 and that faces away from the tuning member 120. For example, when the radiator 110 is thick and is of a T-shaped structure shown in FIG. 13, the fifth isolation layer 191 may support the radiator 110, to reduce or avoid tilting of the radiator 110. This helps improve stability and reliability of disposition of the radiator 110 in the antenna element 100, and improve overall structure stability of the antenna element 100.

Alternatively, as shown in FIG. 14, when the radiator 110 is thick, the radiator 110 may be supported by increasing a thickness of the passivation layer 190, to improve stability and reliability of disposition of the radiator 110. A radiation branch 111 may be further disposed on the radiator 110, and the radiator 110 may further radiate and receive an electromagnetic wave signal by using the radiation branch 111 on the radiator 110, to improve radiation performance of the radiator 110.

In this embodiment of this application, when the tuning member 120 is subjected to a first thermal pulse, the tuning member 120 may transition from a metallic phase to an insulating phase; and when the tuning member 120 is subjected to a second thermal pulse, the tuning member 120 may transition from an insulating phase to a metallic phase. For example, when the control circuit inputs a voltage pulse to the first electrode 132 and the second electrode 133, the voltage pulse flows into the heating member 131, so that the heating member 131 can generate the first thermal pulse, to enable the tuning member 120 to transition from a metallic phase to an insulating phase. When the control circuit inputs another voltage pulse to the first electrode 132 and the second electrode 133, the voltage pulse flows into the heating member 131, so that the heating member 131 can generate the second thermal pulse, to enable the tuning member 120 to transition from an insulating phase to a metallic phase.

FIG. 15 is a diagram of a phase transition principle of a tuning member according to an embodiment of this application.

For example, with reference to FIG. 15, after the control circuit inputs a voltage pulse with a pulse width of a magnitude of tens of nanoseconds and a high amplitude to the first electrode 132 and the second electrode 133, the heating member 131 may generate the first thermal pulse. After being subjected to the first thermal pulse, the tuning member 120 may implement non-volatile conversion from a crystalline state to an amorphous state within a nanosecond timescale, to enable the tuning member 120 to transition from the metallic phase to the insulating phase. In this case, the tuning member 120 that presents the insulating phase does not radiate or receive a signal, and an effective radiation structure of the antenna element 100 is the radiator 110.

After the control circuit inputs an electric pulse with a pulse width ranging from a nanosecond magnitude to a microsecond magnitude and a low voltage amplitude to the first electrode 132 and the second electrode 133, the heating member 131 may generate the second thermal pulse. After being subjected to the second thermal pulse, the tuning member 120 may implement non-volatile conversion from an amorphous state to a crystalline state within a timescale of several nanoseconds to microseconds, to enable the tuning member 120 to transition from the insulating phase to the metallic phase. In this way, electrical conduction can be implemented between the tuning member 120 and the radiator 110. In this case, the tuning member 120 that presents the metallic phase may also radiate and receive a signal, and an effective radiation structure of the antenna element 100 may be understood as a whole mechanical part formed by the radiator 110 and the tuning member 120.

In this embodiment of this application, a shape of the radiator 110 may include at least one of a trapezoid, a sector, a rectangle, a circle, an annulus, or a polygon (where for example, the polygon may be a pentagon or a hexagon). The annular radiator 110 may be of a closed annulus structure, or the radiator 110 may be of an annulus structure having an opening. For example, the antenna element 100 may include two radiators 110, and shapes of the two radiators 110 may be the same, or shapes of the two radiators 110 may be different. For example, a shape of one of the two radiators 110 may be a rectangle, and a shape of the other radiator 110 may be a trapezoid or a triangle.

Alternatively, in some examples, the antenna element 100 may further include a plurality of radiators 110, and shapes of the radiators 110 may be the same, or shapes of the radiators 110 may be different.

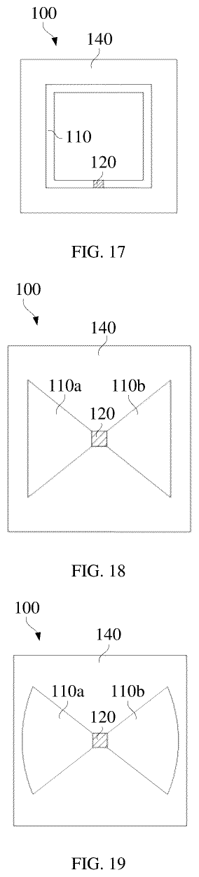

FIG. 16 is a diagram of a structure of a first combination of a radiator and a tuning member according to an embodiment of this application. FIG. 17 is a diagram of a structure of a second combination of a radiator and a tuning member according to an embodiment of this application.

Refer to FIG. 16. For example, in a possible implementation, the antenna element 100 may include one radiator 110 and one tuning member 120. One end of the tuning member 120 may be connected to one end of the radiator 110, and the other end of the tuning member 120 may be connected to the other end of the radiator 110. In other words, the radiator 110 and the tuning member 120 are connected head to tail in sequence to form an annulus structure. When the tuning member 120 transitions from a metallic phase to an insulating phase, the two ends of the radiator 110 are electrically insulated by using the tuning member 120. In this case, the radiator 110 and the tuning member 120 may form an annulus radiation structure having an opening. When the tuning member 120 transitions from an insulating phase to a metallic phase, the two ends of the radiator 110 are electrically connected by using the tuning member 120, so that the radiator 110 and the tuning member 120 can form a closed annulus radiation structure.

Refer to FIG. 16. For example, a shape of the radiator 110 may be a circular annulus structure having an opening shown in the figure, the tuning member 120 may be disposed at the opening of the circular annulus, and the tuning member 120 and the radiator 110 are enclosed to form a closed circular annulus structure. In this way, when the tuning member 120 is in the insulating phase, the effective radiation structure of the antenna element 100 is the circular annulus structure having the opening, that is, in this case, only the radiator 110 in the antenna element 100 radiates and receives an electromagnetic wave signal. When the tuning member 120 is in the metallic phase, the two ends of the radiator 110 may be electrically connected by using the tuning member 120, so that the radiator 110 and the tuning member 120 can form a closed circular annulus metal structure. In this case, the effective radiation structure of the antenna element 100 is a closed circular annulus structure.

Alternatively, as shown in FIG. 17, the radiator 110 may alternatively be of a rectangular annulus structure with an opening shown in the figure, and the tuning member 120 may be disposed at the opening of the rectangular annulus structure. When the tuning member 120 is in the insulating phase, the effective radiation structure of the antenna element 100 is the rectangular annulus structure having the opening. When the tuning member 120 is in the metallic phase, the two ends of the radiator 110 may be electrically connected by using the tuning member 120, so that the radiator 110 and the tuning member 120 can form a closed rectangular annulus metal structure. In this case, the effective radiation structure of the antenna element 100 is a closed rectangular annulus structure.

FIG. 18 is a diagram of a structure of a third combination of a radiator and a tuning member according to an embodiment of this application. FIG. 19 is a diagram of a structure of a fourth combination of a radiator and a tuning member according to an embodiment of this application.

Alternatively, in another possible implementation, as shown in FIG. 18, the antenna element 100 may further include two radiators 110 and one tuning member 120. One end of the tuning member 120 may be connected to one radiator 110, and the other end of the tuning member 120 may be connected to one end of the other radiator 110. For example, the two radiators 110 may be respectively a radiator 110a and a radiator 110b, one end of the tuning member 120 may be connected to one end of the radiator 110a, and the other end of the tuning member 120 may be connected to one end of the radiator 110b. When the tuning member 120 transitions from a metallic phase to an insulating phase, the radiator 110a is electrically insulated from the radiator 110b by using the tuning member 120. In this case, the radiator 110a and the radiator 110b work independently, and radiate and receive electromagnetic wave signals respectively. When the tuning member 120 transitions from an insulating phase to a metallic phase, the radiator 110a may be electrically connected to the radiator 110b by using the tuning member 120. In this case, the radiator 110a, the radiator 110b, and the tuning member 120 may be considered as a whole to radiate and receive an electromagnetic wave signal. The effective radiation structure of the antenna element 100 may be understood as a mechanical part formed by all of the two radiators 110 and the tuning member 120.

Refer to FIG. 18. For example, shapes of the two radiators 110 (the radiator 110a and the radiator 110b) may be both trapezoids, and the two radiators 110 of a trapezoidal structure may be connected by using the tuning member 120. When the tuning member 120 transitions from a metallic phase to an insulating phase, the two trapezoidal radiators 110 are electrically insulated from each other by using the tuning member 120 and work independently. When the tuning member 120 transitions from an insulating phase to a metallic phase, the two trapezoidal radiators 110 are electrically connected by using the tuning member 120, and may work with the tuning member 120 as a whole. Alternatively, as shown in FIG. 19, the radiator 110a and the radiator 110b may alternatively be of a sector structure.

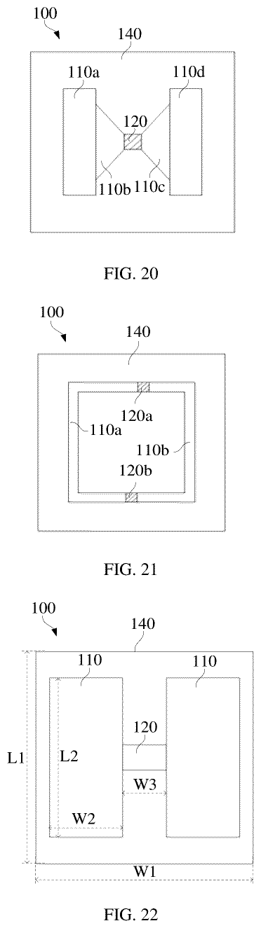

FIG. 20 is a diagram of a structure of a fifth combination of a radiator and a tuning member according to an embodiment of this application.

Alternatively, in some examples, as shown in FIG. 20, each of two radiators 110 may further include two sub radiators 110, and the two sub radiators 110 may be electrically connected to form the radiator 110. In this case, the antenna element 100 may also be understood as including four radiators 110. The four radiators 110 are connected in pairs to form two groups of radiators 110, and the two groups of radiators 110 are connected by using the tuning member 120. In this way, when the tuning member 120 presents different resistance states, the effective radiation structure of the antenna element 100 may also be changed. Refer to FIG. 20. For example, the four radiators 110 may be respectively a radiator 110a, a radiator 110b, a radiator 110c, and a radiator 110d. The radiator 110a may be connected to the radiator 110b, and the radiator 110c may be connected to the radiator 110d. In addition, the radiator 110b may be connected to the radiator 110c by using the tuning member 120. In this way, when the tuning member 120 is in the insulating phase, the antenna element 100 may be considered as two independent radiation structures. One radiation structure is formed by the radiator 110a and the radiator 110b, and the other radiation structure is formed by the radiator 110c and the radiator 110d. The two radiation structures may work independently to radiate and receive an electromagnetic wave signal. On the contrary, when the tuning member 120 is in the metallic phase, the two groups of radiators 110 may be electrically connected by using the tuning member 120, and the four radiators 110 and the tuning member 120 may form an integral structure, to radiate and receive an electromagnetic wave signal.

Shapes of the four radiators 110 and a shape of the tuning member 120 may be a combination of a plurality of forms. Refer to FIG. 20. For example, shapes of the radiator 110a and the radiator 110d may be rectangles, shapes of the radiator 110b and the radiator 110c may be trapezoids, and the shape of the tuning member 120 may be a rectangle. Alternatively, in some examples, the radiators 110 and the tuning member 120 may alternatively be of other structures. The shapes of the radiators 110 and the tuning member 120 may be selected and set based on a specific application scenario.

FIG. 21 is a diagram of a structure of a sixth combination of a radiator and a tuning member according to an embodiment of this application.

In still another possible implementation, there may be at least two tuning members 120, one end of one of the at least two tuning members 120 may be connected to one end of one radiator 110, and the other end of the tuning member 120 may be connected to one end of another radiator 110. One end of another tuning member 120 may be connected to the other end of the radiator 110, and the other end of the another tuning member 120 may be connected to the other end of the another radiator 110.

Refer to FIG. 21. For example, an example in which there are two tuning members 120 and two radiators 110 is used. The two tuning members 120 may be respectively a tuning member 120a and a tuning member 120b, and the two radiators 110 may be respectively a radiator 110a and a radiator 110b. One end of the tuning member 120a may be connected to one end of the radiator 110a, and the other end of the tuning member 120a may be connected to one end of the radiator 110b. One end of the tuning member 120b may be connected to the other end of the radiator 110a, and the other end of the tuning member 120b may be connected to the other end of the tuning member 120b.

In this way, when one of the tuning member 120a and the tuning member 120b transitions from a metallic phase to an insulating phase, for example, when the tuning member 120a is in the insulating phase and the tuning member 120b is in the metallic phase, the radiator 110a, the radiator 110b, and the tuning member 120b may form an annulus radiation structure having an opening. When both the tuning member 120a and the tuning member 120b transition from an insulating phase to a metallic phase, the two tuning members 120 both have conductivities, and the radiator 110a, the radiator 110b, and the two tuning members 120 may form a closed annulus radiation structure.

A plurality of different forms of radiation structures may be implemented by flexibly setting shapes, quantities, and combination forms of the tuning members 120 and the radiators 110. The tuning member 120 is switched to different crystal structures, so that the tuning member 120 presents the metallic phase or the insulating phase, the antenna element 100 can present a plurality of different structure characteristics, and the antenna array 200 can effectively implement rich intelligent reconfigurable forms.

It should be understood that shapes, quantities, and combinations of the radiators 110 and the tuning members 120 in the foregoing several forms are merely several forms listed in this embodiment of this application, and are not all combination forms that can be implemented in this embodiment of this application. In a specific application process, according to this design principle, rich forms of the antenna element 100 may be combined by flexibly setting the shapes, quantities, and combinations of the tuning members 120 and the radiators 110. Specific shapes, quantities, and combination forms of the tuning members 120 and the radiators 110 may be selected and set based on a specific application scenario. This is not limited in this embodiment of this application.

In this embodiment of this application, a forming material of the tuning member 120 may be germanium telluride (GeTe), antimony telluride, germanium antimony telluride, or indium antimony tellurium. Under different temperatures, the foregoing material can stably implement conversion between an amorphous state and a crystalline state. The crystalline state is the metallic phase and is a low-resistance state, and the amorphous state is the insulating phase and is a high-resistance state. In this way, the tuning member 120 can induce transition from the metallic phase to the insulating phase, and a change of a crystal structure and an energy band structure before and after phase transition can cause an electric conductivity of the tuning member 120 to change by five orders of magnitude, so that the tuning member 120 performs conversion between the high-resistance state and the low-resistance state. For example, when the GeTe material is an amorphous insulating phase, resistance of the tuning member 120 may range from KΩ magnitude to MΩ magnitude. When the GeTe material is a crystalline metallic phase, resistance of the tuning member 120 is at an Ω magnitude, and effective switching between conduction and disconnection of the tuning member 120 and the radiator 110 can be effectively implemented, so that the antenna element 100 can perform non-volatile switching on an amplitude or a phase of a target electromagnetic wave, to implement a reconfigurable characteristic of an antenna structure.

In addition, the GeTe material further has features such as a low on-state insertion loss (less than 0.5 dB), large off-state isolation (greater than 15 dB), a high cut-off frequency (about 12 THz), a high phase transition temperature, good environment stability, and a high switching speed of a component (where the switching speed ranges from a nanosecond magnitude to a microsecond magnitude). In addition, the GeTe material is easy to manufacture, is easy to form, and can be manufactured in any size. In addition, the GeTe material is compatible with an existing semiconductor material processing process, and can effectively reduce a difficulty in manufacturing the tuning member 120.

For example, a forming material of the first isolation layer 140 may be at least one or more of aluminum nitride (AlN), silicon nitride (Si₃N₄), silicon dioxide (SiO₂), silicon carbide (SiC), and aluminum oxide (Al₂O₃). For example, the first isolation layer 140 may be a mechanical part made of any one of the foregoing materials, or the first isolation layer 140 may be a mechanical part made of any two or more of the foregoing materials. The foregoing materials all have high heat conductivity, can effectively reduce a heat loss between the heating member 131 and the tuning member 120, and effectively improve heat transmission efficiency between the heating member 131 and the tuning member 120. In addition, the foregoing several materials further have low dielectric constants, and have good electrical isolation, so that circuit conduction between the radiator 110 and the tuning member 120 and the heating member 131 can be effectively reduced or avoided, and a short circuit inside the antenna element 100 is avoided, thereby effectively improving safety of the antenna array 200.

A forming material of the second isolation layer 150 and a forming material of the third isolation layer 180 may also be at least one or more of aluminum nitride (AlN), silicon nitride (Si₃N₄), silicon dioxide (SiO₂), silicon carbide (SiC), and aluminum oxide (Al₂O₃). In this way, electrical isolation between the second isolation layer 150 and the third isolation layer 180 is improved, and a short circuit inside the antenna element 100 is reduced or avoided, thereby effectively improving stability and safety of running of the antenna element 100.

A forming material of the heating member 131 may be metal tungsten (W) or a titanium tungsten alloy (TiW). These materials have good heat resistance and heating efficiency, so that the heating member 131 can quickly convert electric energy into heat energy, thereby helping improve heat conversion efficiency of the heating member 131 and accelerate a response of the antenna element 100.

A forming material of the radiator 110 may be at least one of gold, copper, and aluminum. For example, the radiator 110 may be a mechanical part made of any one of the foregoing materials, or the radiator 110 may be a mechanical part made of any two or more of the foregoing materials. The foregoing material has a good conductivity, and helps improve radiation efficiency of the radiator 110 on an electromagnetic wave, and improve radiation performance of the antenna element 100.

Forming materials of the first electrode 132, the second electrode 133, and the metal backplane 170 may alternatively be at least one of gold, copper, and aluminum. This helps improve conductivities of the first electrode 132 and the second electrode 133.

A forming material of the substrate 160 may be silicon (Si), quartz, sapphire, or silicon carbide (SiC). These materials have high hardness, can improve structure strength and rigidity of the substrate 160, and improve structure stability of the antenna element 100.

The following performs a simulation test on the antenna element 100 provided in this embodiment of this application with reference to the accompanying drawings.

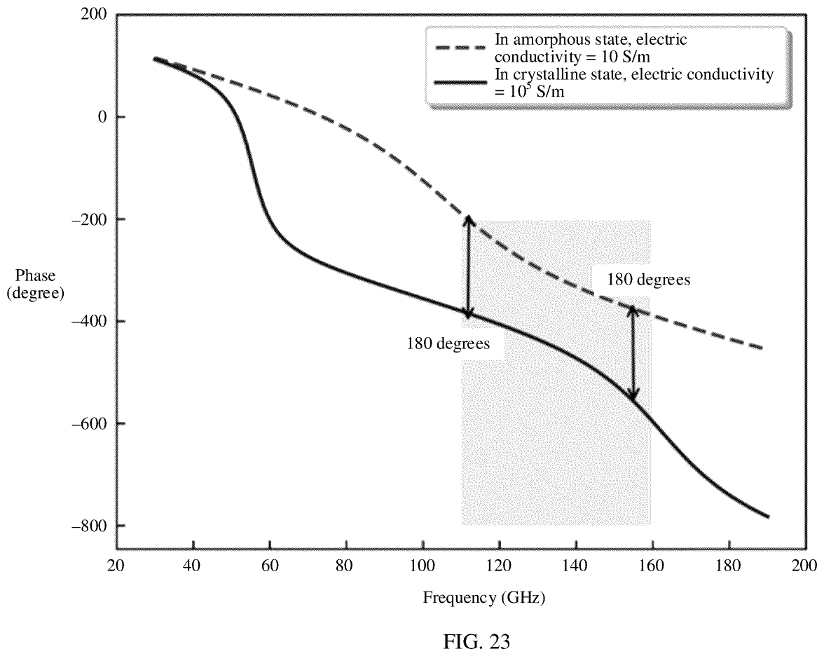

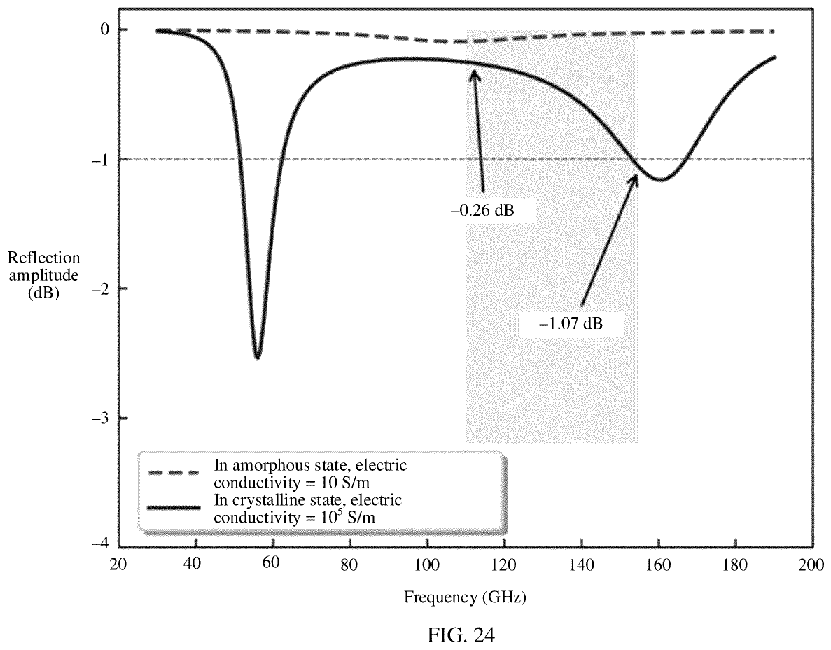

FIG. 22 is a diagram of a size of an antenna element according to an embodiment of this application. FIG. 23 is a diagram of comparison between antenna phases of an antenna element when a tuning member is in a metallic phase and an insulating phase according to an embodiment of this application. FIG. 24 is a diagram of comparison between antenna reflection amplitudes of an antenna element when a tuning member is in a metallic phase and an insulating phase according to an embodiment of this application.

Refer to FIG. 22. An example in which the antenna element 100 includes two radiators 110 and one tuning member 120 is used. Sizes of the two radiators 110 may be the same. The tuning member 120 may be disposed between the two tuning radiators 110. One end of the tuning member 120 may be connected to one of the radiators 110, and the other end of the tuning member 120 may be connected to the other radiator 110. As shown in the figure, in the test, a length of the antenna element 100 may be L1, which may be 1 mm, a width of the antenna element 100 may be W1, and a value of W1 may also be 1 mm. A shape of the radiator 110 may be a rectangle. In addition, a length of the rectangular radiator 110 may be L2, which may be 0.8 mm, a width of the radiator 110 may be W2, which may be 0.44 mm. A width of the tuning member 120 may be W3, and a value of W3 may be 0.05 mm.

When the tuning member 120 is in the insulating phase, the tuning member 120 presents a high-resistance state, and in this case, an electric conductivity of the tuning member 120 is 10 S/m. When the tuning member 120 is in the metallic phase, the tuning member 120 presents a low-resistance state, and in this case, an electric conductivity of the tuning member 120 is 10⁵ S/m. Refer to FIG. 23. In the figure, the dashed line represents an antenna phase pattern when the tuning member 120 is in an amorphous state (that is, the insulating phase), while the solid line represents an antenna phase pattern when the tuning member 120 is in a crystalline state (that is, the metallic phase). It can be learned from FIG. 23 that, at frequencies 112 GHz and 155 GHz, the antenna element 100 implements phase control of 180° in a metal-insulator transition process of the tuning member 120. This indicates that the tuning member 120 can effectively implement phase control of the antenna element 100 in the metal-insulator transition process.

Refer to FIG. 24. In the figure, the dashed line represents an antenna reflection amplitude pattern when the tuning member 120 is in an amorphous state (that is, the insulating phase), while the solid line represent an antenna reflection amplitude pattern when the tuning member 120 is in a crystalline state (that is, the metallic phase). It can be learned from FIG. 24 that, in a frequency band from 112 GHz to 155 GHz, a reflection amplitude of the antenna element 100 reaches—1 dB in a metal-insulator transition process of the tuning member 120. This indicates that the antenna element 100 has a reflection amplitude of a low loss in the metal-insulator transition process of the tuning member 120.

An embodiment of this application further provides a communication apparatus. The communication apparatus may include the antenna array 200 in any one of the foregoing examples. For example, the communication apparatus may be a programmable holographic imaging system, an adaptive intelligent sensing system, a new-system wireless communication system, or a communication base station. The communication apparatus includes the foregoing antenna array 200, so that mounting space occupied by the antenna array 200 in the communication apparatus can be effectively reduced, and rationality of arrangement of the antenna array 200 in the communication apparatus is improved, thereby helping improve a miniaturization design of the communication apparatus. In addition, a production difficulty and production costs of a communication antenna in the communication apparatus can be further reduced, and a production difficulty and production costs of the communication apparatus can be reduced.

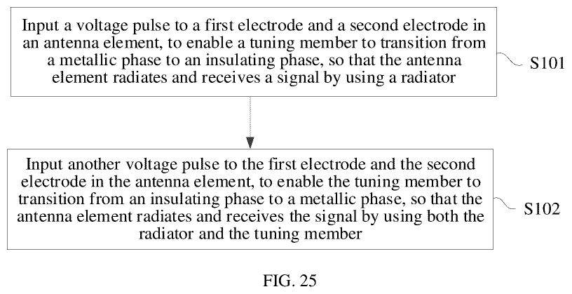

FIG. 25 is a flowchart of a control method of an antenna element according to an embodiment of this application.

An embodiment of this application further provides a control method, which may be used to control the antenna element 100 provided in any one of the foregoing examples. Refer to FIG. 25. The method may include the following steps.

S101: Input a voltage pulse to a first electrode 132 and a second electrode 133 in the antenna element 100, to enable a tuning member 120 to transition from a metallic phase to an insulating phase, so that the antenna element 100 radiates and receives a signal by using a radiator 110.

For example, an electric pulse with a pulse width of a magnitude of tens of nanoseconds and a voltage amplitude of more than 10 V may be input to the first electrode 132 and the second electrode 133, so that a heating member 131 in the antenna element 100 can convert the voltage pulse into a first thermal pulse after being subjected to the voltage pulse. In this case, after being subjected to the first thermal pulse, the tuning member 120 may transition from a metallic phase to an insulating phase. In other words, the tuning member 120 is an insulation member, and does not radiate or receive an electromagnetic wave signal. The antenna element 100 radiates and receives an electromagnetic wave signal only by using the radiator 110.

S102: Input another voltage pulse to the first electrode 132 and the second electrode 133 in the antenna element 100, to enable the tuning member 120 to transition from an insulating phase to a metallic phase, so that the antenna element 100 radiates and receives the signal by using both the radiator 110 and the tuning member 120.

For example, an electric pulse with a pulse width ranging from a nanosecond magnitude to a microsecond magnitude and a voltage amplitude ranging from 1 V to 10 V may be input to the first electrode 132 and the second electrode 133, so that the heating member 131 in the antenna element 100 can convert the voltage pulse into a second thermal pulse after being subjected to the voltage pulse. In this case, after being subjected to the second thermal pulse, the tuning member 120 may transition from an insulating phase to a metallic phase. In other words, the tuning member 120 is a conductive member, and may radiate and receive the electromagnetic wave signal. The antenna element 100 may radiate and receive the electromagnetic wave signal by using both the radiator 110 and the tuning member 120.

In the descriptions of embodiments of this application, it should be noted that unless otherwise clearly specified and limited, the terms “mounting”, “interconnection”, and “connection” should be understood in a broad sense. For example, there may be a fixed connection, may be an indirect connection through an intermediate medium, or may be an internal connection between two elements or an interaction relationship between two elements. A person of ordinary skill in the art may understand specific meanings of the foregoing terms in embodiments of this application based on specific cases. The terms such as “first”, “second”, “third”, “fourth”, and the like (if any) are intended to distinguish between similar objects but do not necessarily indicate a specific order or sequence.

Finally, it should be noted that the foregoing embodiments are merely used to describe the technical solutions in embodiments of this application, but not to limit the technical solutions. Although embodiments of this application are described in detail with reference to the foregoing embodiments, a person of ordinary skill in the art should understand that the technical solutions recorded in the foregoing embodiments may still be modified, or some or all of technical features thereof may be equivalently replaced. However, these modifications or replacements do not depart from the scope of the technical solutions in embodiments of this application.

1.-20. (canceled)

21. An antenna element, comprising:
a radiator;
a tuning member connected to the radiator; and
an electronic control component, wherein:
the electronic control component comprises a heating member, a first electrode, and a second electrode;
one end of the heating member is connected to the tuning member, another end of the heating member is electrically connected to both one end of the first electrode and one end of the second electrode, and both another end of the first electrode and another end of the second electrode are electrically connected to a control circuit;
the heating member is configured to convert a voltage pulse into a thermal pulse, and conduct the thermal pulse to the tuning member, when the control circuit inputs the voltage pulse to the first electrode and the second electrode; and
the tuning member transitions between a metallic phase and an insulating phase when subjected to the thermal pulse.

22. The antenna element according to claim 21, wherein:
the tuning member transitions from the metallic phase to the insulating phase when being subjected to a first thermal pulse; and
the tuning member transitions from the insulating phase to the metallic phase when being subjected to a second thermal pulse.

23. The antenna element according to claim 21, wherein the antenna element further comprises a first isolation layer located between the heating member, the tuning member, and the radiator; and
the tuning member is connected to the heating member via the first isolation layer.

24. The antenna element according to claim 23, wherein a forming material of the first isolation layer is at least one of aluminum nitride, silicon nitride, silicon dioxide, silicon carbide, and aluminum oxide.

25. The antenna element according to claim 23, wherein the antenna element further comprises a second isolation layer located on a side of the first isolation layer that faces away from the tuning member and the radiator; and
a surface of the second isolation layer defines a mounting groove that faces the tuning member and the radiator, and the heating member is located in the mounting groove.

26. The antenna element according to claim 25, wherein a forming material of the second isolation layer is at least one of aluminum nitride, silicon nitride, silicon dioxide, silicon carbide, and aluminum oxide.

27. The antenna element according to claim 25, wherein two first through holes are defined in the mounting groove that extend distally away from the tuning member and the radiator, and the first electrode and the second electrode respectively pass through the two first through holes.

28. The antenna element according to claim 27, wherein the antenna element further comprises at least one of a substrate and a metal backplane.

29. The antenna element according to claim 28, wherein the antenna element comprises the substrate and the metal backplane, the substrate is located on a surface of the second isolation layer that faces away from the tuning member and the radiator, and the metal backplane is located on a surface of the substrate that faces away from the second isolation layer;
the substrate defines two second through holes that are each in communication with a respective one of the two first through holes, and the metal backplane defines two third through holes that are each in communication with a respective one of the second through holes; and
the first electrode and the second electrode further pass through the second through holes and the third through holes in sequence.

30. The antenna element according to claim 29, further comprising a third isolation layer, wherein the third isolation layer is located on a surface of the metal backplane that faces away from the substrate; and
the third isolation layer defines two fourth through holes that are each in communication with a respective one of the third through holes, and the first electrode and the second electrode further pass through the fourth through holes.

31. The antenna element according to claim 21, further comprising a second radiator, wherein one end of the tuning member is connected to one end of the radiator, and another end of the tuning member is connected to one end of the second radiator.

32. The antenna element according to claim 31, wherein when the tuning member transitions from the metallic phase to the insulating phase, the radiator is electrically insulated from the second radiator via the tuning member; and
when the tuning member transitions from the insulating phase to the metallic phase, the radiator is electrically connected to the second radiator via the tuning member.

33. The antenna element according to claim 21, wherein one end of the tuning member is connected to one end of the radiator, and another end of the tuning member is connected to another end of the radiator.

34. The antenna element according to claim 21, wherein there are at least two tuning members, one end of one of the at least two tuning members is connected to one end of one radiator, and another end of the one of the at least two tuning members is connected to one end of another radiator; and
one end of another tuning member in the at least two tuning members is connected to another end of the radiator, and another end of the another tuning member of the at least two tuning members is connected to another end of the another radiator.

35. The antenna element according to claim 21, wherein a shape of the radiator comprises at least one of a trapezoid, a sector, a rectangle, a circle, an annulus, or a polygon.

36. The antenna element according to claim 21, wherein the antenna element further comprises a passivation layer, and the passivation layer covers at least the tuning member.

37. The antenna element according to claim 21, comprising at least one of the following:
a forming material of the tuning member is at least one of germanium telluride, antimony telluride, germanium antimony tellurium, and indium antimony tellurium;
a forming material of the heating member is metal tungsten or titanium tungsten alloy; or
a forming material of the radiator is at least one of gold, copper, and aluminum.

38. An antenna array, the antenna array comprising a plurality of antenna elements, wherein each of the plurality of antenna elements comprises:
a radiator;
a tuning member connected to the radiator; and
an electronic control component, wherein:
the electronic control component comprises a heating member, a first electrode, and a second electrode;
one end of the heating member is connected to the tuning member, another end of the heating member is electrically connected to both one end of the first electrode and one end of the second electrode, and both another end of the first electrode and another end of the second electrode are electrically connected to a control circuit;
the heating member is configured to convert a voltage pulse into a thermal pulse, and conduct the thermal pulse to the tuning member, when the control circuit inputs the voltage pulse to the first electrode and the second electrode; and
the tuning member transitions between a metallic phase and an insulating phase when subjected to the thermal pulse.

39. A communication apparatus, comprising an antenna array, wherein the antenna array comprises a plurality of antenna elements;
wherein each one of the antenna elements comprises:
a radiator;
a tuning member connected to the radiator; and
an electronic control component, wherein:
the electronic control component comprises a heating member, a first electrode, and a second electrode;
one end of the heating member is connected to the tuning member, another end of the heating member is electrically connected to both one end of the first electrode and one end of the second electrode, and both another end of the first electrode and another end of the second electrode are electrically connected to a control circuit;
the heating member is configured to convert a voltage pulse into a thermal pulse, and conduct the thermal pulse to the tuning member, when the control circuit inputs the voltage pulse to the first electrode and the second electrode; and
the tuning member transitions between a metallic phase and an insulating phase when subjected to the thermal pulse.

40. The communication apparatus according to claim 39, wherein:
the tuning member transitions from the metallic phase to the insulating phase when being subjected to a first thermal pulse; and
the tuning member transitions from the insulating phase to the metallic phase when being subjected to a second thermal pulse.
